(19) United States
(12) Patent Application Publication
(10) Pub. No.: US 2025/0000297 A1
(43) Pub. Date: Jan. 2, 2025

(54) Automated Tea Brewing Apparatus and Related Methods

(71) Applicant: Jefferey Raymond Gutterud, Vista, CA (US)

(72) Inventor: Jefferey Raymond Gutterud, Vista, CA (US)

(21) Appl. No.: 18/215,956

(22) Filed: Jun. 29, 2023

(51) Int. Cl. A47J 31/52

(52) U.S. Cl. CPC A47J 31/521; A47J 31/5253; A47J 2202/00

(57) ABSTRACT

An automated tea brewing apparatus and method for brewing a perfect cup of tea is provided. The apparatus includes a heating chamber and an infusion chamber within a housing. A user interface on the housing exterior, a wireless communications module, and a controller are integrated into the apparatus. The controller implements an automated brewing process according to user-defined or pre-set instructions, which include water temperature and steep time. The controller heats the liquid in the heating chamber to the set temperature, allows it to flow into the infusion chamber for a defined steeping period, and then drains the brewed tea into a cup. The apparatus can be controlled via an external device like a smartphone, through a companion app.

### FIELD OF INVENTION

The present invention relates generally to beverage making apparatuses, and more specifically to an automated tea brewing apparatus which enables a user to control all aspects of the tea brewing process, including temperature and steep time, via a companion smartphone application or user interface on the machine.

### BACKGROUND

Tea is a well-loved beverage that is consumed globally and is well-known for its therapeutic, medicinal and calming properties. The art of making tea, however, is often seen as an arduous task requiring precise control of the water temperature and steep time to extract the optimum flavors of the tea leaves. Traditionally, tea is prepared by steeping tea leaves in hot water which requires constant attention and manual control over the temperature and steep time, leading to variations in taste, flavor and quality.

Automated tea brewing machines have been developed to address the challenge of consistently preparing high-quality tea. These machines, however, often lack flexibility and control over the brewing parameters such as temperature and steep time. Most commercially available tea brewing machines come with preset temperatures and steep times, which are not suitable for all types of tea leaves, leading to suboptimal extraction of flavors.

Furthermore, these automated tea brewing machines often lack user-friendly interfaces and have complex operational requirements. In some cases, these machines require manual input for temperature and steep time, which could be challenging for the average user. Most of these machines do not offer the option to select a brewing profile from a pre-determined list, which can make the process of brewing different types of tea more complicated than it needs to be.

Additionally, existing automated tea brewing machines often fail to provide an accurate estimate of the time required to brew a certain type of tea. This lack of predictability can lead to over-steeped or under-steeped tea, affecting the overall tea drinking experience.

Moreover, most of these machines lack the capability to communicate with an external device such as a smartphone, limiting the user's ability to monitor and control the brewing process remotely. This lack of remote control and monitoring capability is a significant disadvantage, especially for users who have busy schedules and cannot afford to continuously monitor the tea brewing process.

Thus, there exists a need in the art for an improved automated tea brewing machine that provides the user with enhanced control over the brewing parameters, a user-friendly interface, the ability to monitor and control the brewing process remotely, and efficient management of tea supplies.

It is within this context that the present invention is provided.

### SUMMARY

The present invention provides an automated tea brewing apparatus and a method of use for the preparation of a perfect cup of tea, offering users an unprecedented level of control over all aspects of the brewing process. The invention aims to address the disadvantages of prior automated tea brewing machines, enhancing user experience and improving tea brewing efficiency.

In one aspect, the invention comprises an automated tea brewing apparatus with two separate chambers-a heating chamber and an infusion chamber-arranged in a housing. The heating chamber is positioned above the infusion chamber and includes an electronically controlled valve that allows the flow of water from the heating chamber to the infusion chamber. The infusion chamber is equipped with a similar electronically controlled valve that directs the flow of the steeped tea onto a support platform below, designed to accommodate a teacup or teapot. Both chambers are sealed except for the lid and valve openings.

A user interface is situated on the exterior of the housing, consisting of one or more buttons or touchscreens. A wireless communications module and a controller, such as a microprocessor, are positioned within the housing, enabling the automation of the brewing process based on a set of instructions received from an external device, like a smartphone, or via the user interface. The instructions can manually be set by the user or selected from a pre-set brewing profile for optimal temperature and steep time.

The brewing apparatus may also include a temperature sensor placed within the heater chamber to monitor and regulate the heating process. The user can control the process via a companion app on their smartphone, allowing for a remote, convenient brewing experience. The app also maintains a list of brewing profiles for various types of infusions, easing the selection process for the user.

In addition, the invention may include a feature to scan QR codes on tea packaging to import the brewing profile for a particular tea directly into the app, streamlining the brewing process further. Furthermore, the app may keep a record of the number of drinks poured, enabling it to predict when the user might run out of tea and alert them to purchase more.

The invention provides an efficient and customizable brewing process, bridging the gap between traditional tea brewing methods and modern convenience, thereby revolutionizing the tea brewing experience.

### BRIEF DESCRIPTION OF THE DRAWINGS

Various embodiments of the invention are disclosed in the following detailed description and accompanying drawings.

FIG. 1 is an isometric perspective view of the automated tea brewing apparatus. The housing, hinged lid of the heater chamber, touchscreen user interface with two buttons, opening in the side wall of the infusion chamber, and the support platform below the infusion chamber designed to support a teacup or teapot are clearly visible.

FIG. 2 presents a cross-sectional view from the side of the automated tea brewing apparatus. The heater chamber positioned above the infusion chamber is shown, with both the heater and infusion chamber valves in clear view. The placement of the controller and wireless communications module within the housing is also displayed, demonstrating how the gravity-driven brewing process is achieved.

FIG. 3 is a flow diagram depicting the sequence of steps executed by the apparatus controller and a smartphone during an automated brewing process. The example given illustrates the brewing process for chamomile tea, selected via the companion app, and details each software operation required for successful completion.

FIG. 4 provides a flow diagram of the process for adding a new brewing profile to the companion app. This includes the process of scanning a QR code on a tea package to import the specific brewing parameters provided by the tea manufacturer.

Common reference numerals are used throughout the figures and the detailed description to indicate like elements. One skilled in the art will readily recognize that the above figures are examples and that other architectures, modes of operation, orders of operation, and elements/functions can be provided and implemented without departing from the characteristics and features of the invention, as set forth in the claims.

### DETAILED DESCRIPTION AND PREFERRED EMBODIMENT

The following is a detailed description of exemplary embodiments to illustrate the principles of the invention. The embodiments are provided to illustrate aspects of the invention, but the invention is not limited to any embodiment. The scope of the invention encompasses numerous alternatives, modifications and equivalent; it is limited only by the claims.

Numerous specific details are set forth in the following description in order to provide a thorough understanding of the invention. However, the invention may be practiced according to the claims without some or all of these specific details. For the purpose of clarity, technical material that is known in the technical fields related to the invention has not been described in detail so that the invention is not unnecessarily obscured.

### Definitions

The terminology used herein is for the purpose of describing particular embodiments only and is not intended to be limiting of the invention.

As used herein, the term “and/or” includes any combinations of one or more of the associated listed items.

As used herein, the singular forms “a,” “an,” and “the” are intended to include the plural forms as well as the singular forms, unless the context clearly indicates otherwise.

It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

The terminology used herein is for the purpose of describing particular embodiments only and is not intended to be limiting.

The terms “first,” “second,” and the like are used herein to describe various features or elements, but these features or elements should not be limited by these terms. These terms are only used to distinguish one feature or element from another feature or element. Thus, a first feature or element discussed below could be termed a second feature or element, and similarly, a second feature or element discussed below could be termed a first feature or element without departing from the teachings of the present disclosure.

### DESCRIPTION OF DRAWINGS

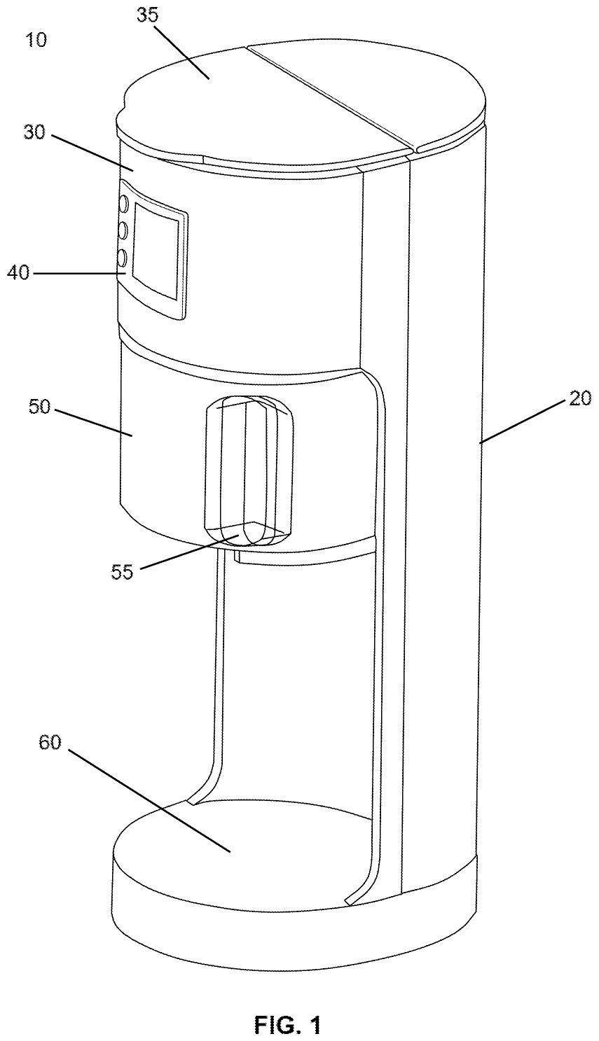

FIG. 1 depicts an exemplary embodiment of the automated tea brewing apparatus 10 according to the invention. The apparatus 10 includes a housing 20 which is structured to accommodate the various components of the apparatus. The housing 20 provides a structured shape and also acts as a protective casing for the internal parts of the automated tea brewing apparatus 10.

Located at the upper region of the housing 20 is a heating chamber 30 with a hinged or removable lid 35. The lid 35 is designed to permit the user to pour water into the heating chamber 30. The heating chamber 30 is devised to heat the liquid to the desired temperature based on the user's selection or a pre-set brewing profile.

Positioned on the housing 20 is a user interface 40, equipped with a touchscreen and buttons. The user interface 40 is engineered to receive user inputs, allowing the user to set the temperature and steeping time manually, or to select a pre-set brewing profile. The user interface 40 is ergonomically designed to provide an easy and user-friendly interaction with the apparatus.

Directly below the heating chamber 30 within the housing 20, is an infusion chamber 50. This chamber is designed to hold tea leaves, tea bags, or other infusion substances. The infusion chamber 50 is detachable with an open top and includes a chamber 55 for holding the infusion, preferably located on the sidewall of the chamber. Alternatively, the tea/infusion can be placed directly into the chamber. This design permits easy access for the user to add their selected tea or infusion substance.

The infusion chamber side wall may be of a transparent material, allowing a user to watch the steeping process.

Situated beneath the infusion chamber 50 is a support platform 60, positioned within an open space in the lower region of the housing 20. The support platform 60 is dimensioned and arranged to support a teacup or teapot. The platform may in some examples also have a drain catch for overfilled or spilled liquids.

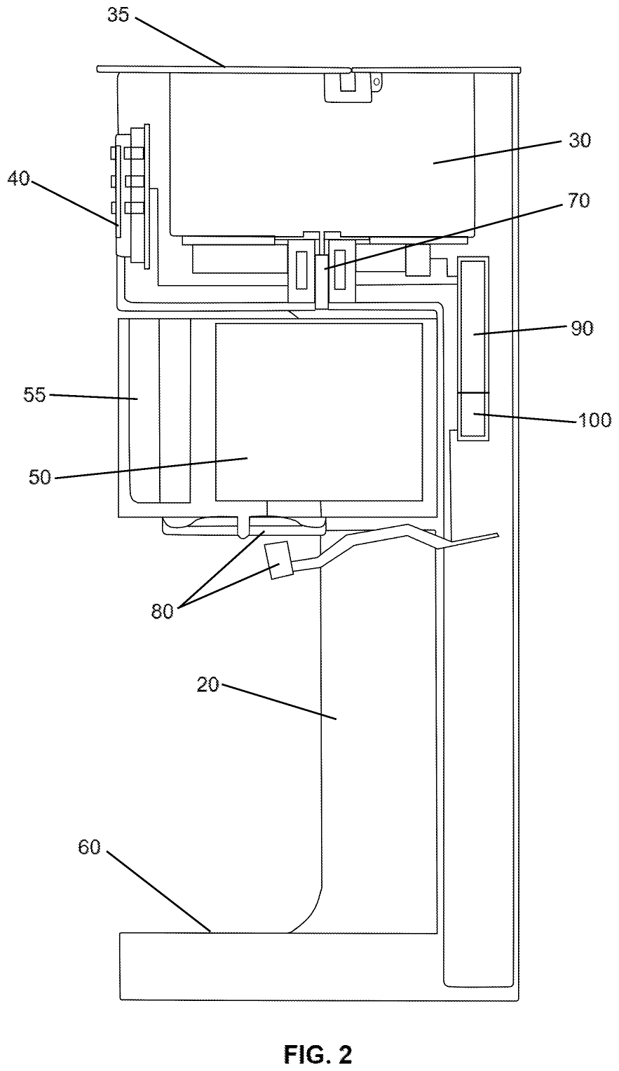

FIG. 2 provides a cross-sectional view of the automated tea brewing apparatus 10 from the side, enabling a clearer understanding of the internal arrangement of the components.

As shown, the heating chamber 30 is positioned directly above the infusion chamber 50 within the housing 20. The housing 20 can be constructed from a variety of durable and heat-resistant materials, such as high-grade plastic, metal, or a composite material, in order to ensure the integrity and safety of the device during operation and allow for higher operating temperatures.

The heating chamber 30 is connected to the infusion chamber 50 through an electronically controlled heating chamber valve 70. This valve can be any suitable type of valve that can effectively control the flow of liquid between the two chambers, such as a solenoid valve, a ball valve, a gate valve, or a butterfly valve. The valve 70 is controlled by the controller to precisely open at the desired moment once the water has reached the pre-set temperature.

Beneath the infusion chamber 50, an electronically controlled infusion chamber valve 80 is positioned on the floor of the infusion chamber. This valve 80, similar to the heating chamber valve 70, can be of any suitable type capable of controlling the flow of liquid from the infusion chamber. The location of the valve directly above the support platform 60 is advantageous, as it allows the brewed tea to flow directly into a teacup or teapot positioned on the platform. This arrangement facilitates a gravity-driven brewing process, eliminating the need for additional pumping mechanisms and thereby simplifying the device's operation and maintenance.

Within the infusion chamber 50, a user can place their selected infusion substance, which can range from traditional tea leaves or tea bags, to other infusion substances such as herbal tea, tisane, or medicinal herbs. This feature provides the user with a broad spectrum of choices to suit their personal taste preferences or health needs.

The controller 90 and wireless communications module 100 are compactly integrated within a single chip embedded within the housing 20. The controller 90 is designed to manage the brewing process based on the user's instructions or pre-set brewing profiles, while the wireless communications module 100 facilitates remote control and monitoring of the device via an external device such as a smartphone.

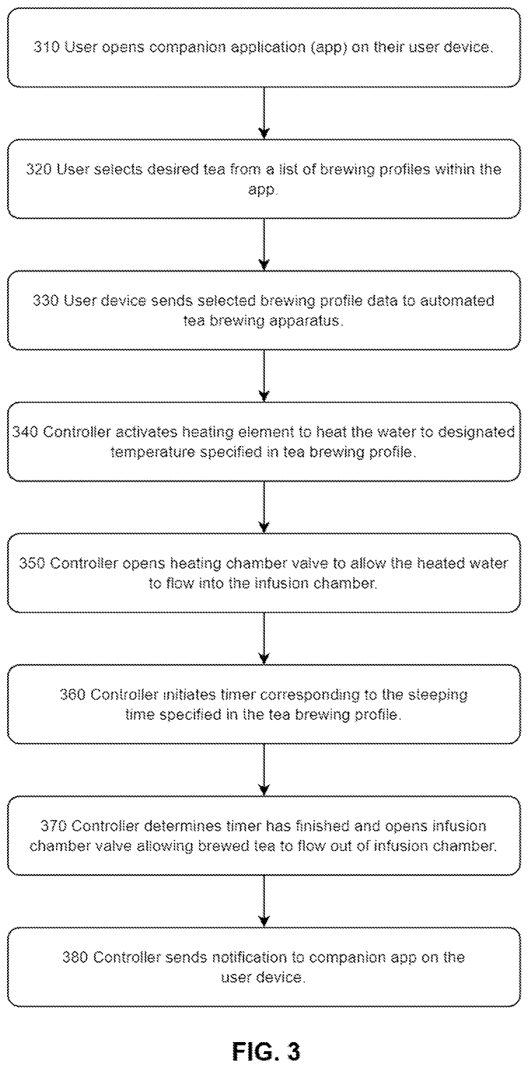

Moving onto FIG. 3, a flow diagram illustrating the steps carried out by the controller 90 of the automated tea brewing apparatus 10, and a smartphone during an automated brewing process, is shown.

In step 310, the process begins with the user opening the companion application (app) on their smartphone. The companion app is designed to communicate with the automated tea brewing apparatus 10 via the wireless communication module 100 embedded within the device.

Once the app is opened, in step 320, the user selects their desired tea from a pre-existing list of brewing profiles within the app. In this case, the user selects chamomile tea. Each brewing profile contains specific parameters including the ideal water temperature and steeping time for that particular type of tea or infusion.

Upon selection, in step 330, the app sends the selected brewing profile data to the automated tea brewing apparatus 10 via the wireless communication module 100. This data transfer process is implemented using standard data transmission protocols suitable for the chosen communication technology (e.g., Bluetooth, Wi-Fi).

The controller 90 within the automated tea brewing apparatus 10 receives the brewing profile data. The controller 90 is programmed to interpret this data and execute the corresponding actions to perform the brewing process.

Following this, in step 340, the controller 90 activates the heating element within the heating chamber 30 to heat the water to the designated temperature specified in the chamomile tea brewing profile. The controller 90 can monitor the temperature within the heating chamber 30 and precisely control the heating process to ensure the water reaches the desired temperature.

Once the water has reached the designated temperature, in step 350, the controller 90 opens the electronically controlled heating chamber valve 70 to allow the heated water to flow into the infusion chamber 50, where the chamomile tea or infusion substance has been placed by the user.

Next, in step 360, the controller 90 initiates a timer corresponding to the steeping time specified in the chamomile tea brewing profile. During this steeping time, the heated water interacts with the chamomile tea, infusing the water with the flavors and beneficial compounds of the tea.

Upon completion of the steeping time, in step 370, the controller 90 opens the electronically controlled infusion chamber valve 80, allowing the brewed chamomile tea to flow out of the infusion chamber 50 and into the teacup or teapot positioned on the support platform 60.

Finally, in step 380, a notification that the tea is ready is sent from the controller 90 through the wireless communication module 100 to the companion app on the user's smartphone. This ensures the user is promptly informed when their perfectly brewed chamomile tea is ready to enjoy.

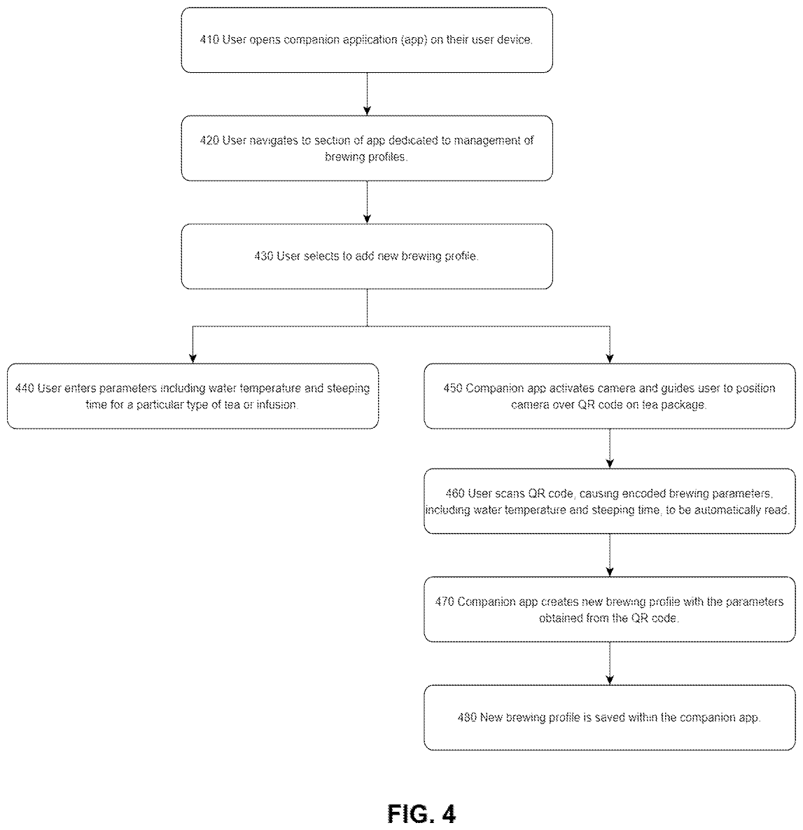

Referring now to FIG. 4, a flow diagram is illustrated that describes the process for adding a new brewing profile to the companion app for the automated tea brewing apparatus 10, including the innovative process of scanning a QR code on a tea package to import brewing parameters.

Beginning with step 410, the user opens the companion app on their smartphone or other compatible device. This app communicates directly with the automated tea brewing apparatus 10, allowing the user to control the brewing process, select from a range of pre-set brewing profiles, and even add new ones.

Once the app is opened, the user will navigate to a menu or section of the app dedicated to the management of brewing profiles, as seen in step 420. Here, the user will have the option to add a new brewing profile.

In step 430, the user selects to add a new brewing profile. The app will then provide two options: manual input or scanning a QR code. The manual input option allows the user to enter the parameters like the ideal water temperature and steeping time for a particular type of tea or infusion as shown in step 440, this can also include selecting the parameters from a pre-built look-up table in the app. However, for simplicity and precision, the user can also choose to scan a QR code that comes on the package of a particular tea brand or type.

Moving to step 450, the user selects the option to scan a QR code. The companion app then activates the smartphone's camera and guides the user to position the camera over the QR code on the tea package.

Upon scanning the QR code in step 460, the brewing parameters encoded within the QR code, such as the specific temperature and steep time recommended by the tea manufacturer, are automatically read by the companion app.

In step 470, the app processes this data and creates a new brewing profile with the parameters obtained from the QR code. The user is then given the option to name the profile, perhaps according to the specific tea type or brand, to make it easily identifiable for future brewing.

Finally, in step 480, the new brewing profile is saved within the companion app. Now, the user can select this profile at any time to brew a perfect cup of tea based on the precise parameters provided by the tea manufacturer.

### Companion App

When the companion app is opened on a compatible device such as a smartphone, tablet, or similar device, the initial screen is displayed. This initial screen may include a variety of options such as starting a new brewing process, editing existing brewing profiles, adding new brewing profiles, viewing brewing history, and accessing settings or help features.

On the new brewing process screen, a list of pre-set brewing profiles is displayed. Each item in the list represents a different tea variety or infusion, with an associated set of brewing parameters including optimal water temperature and steep time. The list can be navigated by scrolling up and down, allowing the user to browse through a multitude of tea varieties. These brewing profiles can range from common types of tea such as black, green, and chamomile, to more exotic blends, herbal infusions, or medicinal brews.

Each item in the list may includes the name of the tea or infusion, a brief description, and may also show an icon or picture related to the specific tea or infusion, aiding the user in making their selection. In addition, each profile may include more detailed information accessible by selecting the profile, which would bring up a detailed view with further information about the tea or infusion, the optimal brewing parameters, and possibly even tasting notes or health benefits.

Once the user selects a brewing profile from the list by tapping on it, the companion app communicates with the automated tea brewing apparatus, sending the brewing parameters associated with the selected profile to the apparatus controller. This initiates the brewing process, with the apparatus heating the water to the designated temperature, steeping the tea for the designated amount of time, and notifying the user upon completion.

The companion app's intuitive, user-friendly interface simplifies the brewing process, allowing users to brew a perfect cup of tea with just a few taps, based on precise parameters set by tea experts or manufacturers. This alleviates the user from the complexities and uncertainties of traditional tea brewing methods, ensuring a consistently excellent cup of tea every time.

### Network Components

A controller as described herein can be any suitable type of computer. A computer may be a uniprocessor or multiprocessor machine. Accordingly, a computer may include one or more processors and, thus, the aforementioned computer system may also include one or more processors. Examples of processors include sequential state machines, microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), gated logic, programmable control boards (PCBs), and other suitable hardware configured to perform the various functionality described throughout this disclosure.

Additionally, the computer may include one or more memories. Accordingly, the aforementioned computer systems may include one or more memories. A memory may include a memory storage device or an addressable storage medium which may include, by way of example, random access memory (RAM), static random access memory (SRAM), dynamic random access memory (DRAM), electronically erasable programmable read-only memory (EEPROM), programmable read-only memory (PROM), erasable programmable read-only memory (EPROM), hard disks, floppy disks, laser disk players, digital video disks, compact disks, video tapes, audio tapes, magnetic recording tracks, magnetic tunnel junction (MTJ) memory, optical memory storage, quantum mechanical storage, electronic networks, and/or other devices or technologies used to store electronic content such as programs and data. In particular, the one or more memories may store computer executable instructions that, when executed by the one or more processors, cause the one or more processors to implement the procedures and techniques described herein. The one or more processors may be operably associated with the one or more memories so that the computer executable instructions can be provided to the one or more processors for execution. For example, the one or more processors may be operably associated to the one or more memories through one or more buses. Furthermore, the computer may possess or may be operably associated with input devices (e.g., a keyboard, a keypad, controller, a mouse, a microphone, a touch screen, a sensor) and output devices such as (e.g., a computer screen, printer, or a speaker).

The computer may advantageously be equipped with a network communication device such as a network interface card, a modem, or other network connection device suitable for connecting to one or more networks.

A computer may advantageously contain control logic, or program logic, or other substrate configuration representing data and instructions, which cause the computer to operate in a specific and predefined manner as, described herein. In particular, the computer programs, when executed, enable a control processor to perform and/or cause the performance of features of the present disclosure. The control logic may advantageously be implemented as one or more modules. The modules may advantageously be configured to reside on the computer memory and execute on the one or more processors. The modules include, but are not limited to, software or hardware components that perform certain tasks. Thus, a module may include, by way of example, components, such as, software components, processes, functions, subroutines, procedures, attributes, class components, task components, object-oriented software components, segments of program code, drivers, firmware, micro code, circuitry, data, and/or the like.

The control logic conventionally includes the manipulation of digital bits by the processor and the maintenance of these bits within memory storage devices resident in one or more of the memory storage devices. Such memory storage devices may impose a physical organization upon the collection of stored data bits, which are generally stored by specific electrical or magnetic storage cells.

The control logic generally performs a sequence of computer-executed steps. These steps generally require manipulations of physical quantities. Usually, although not necessarily, these quantities take the form of electrical, magnetic, or optical signals capable of being stored, transferred, combined, compared, or otherwise manipulated. It is conventional for those skilled in the art to refer to these signals as bits, values, elements, symbols, characters, text, terms, numbers, files, or the like. It should be kept in mind, however, that these and some other terms should be associated with appropriate physical quantities for computer operations, and that these terms are merely conventional labels applied to physical quantities that exist within and during operation of the computer based on designed relationships between these physical quantities and the symbolic values they represent.

It should be understood that manipulations within the computer are often referred to in terms of adding, comparing, moving, searching, or the like, which are often associated with manual operations performed by a human operator. It is to be understood that no involvement of the human operator may be necessary, or even desirable. The operations described herein are machine operations performed in conjunction with the human operator or user that interacts with the computer or computers.

It should also be understood that the programs, modules, processes, methods, and the like, described herein are but an exemplary implementation and are not related, or limited, to any particular computer, apparatus, or computer language. Rather, various types of general-purpose computing machines or devices may be used with programs constructed in accordance with some of the teachings described herein. In some embodiments, very specific computing machines, with specific functionality, may be required.

Unless otherwise defined, all terms (including technical terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

The disclosed embodiments are illustrative, not restrictive. While specific configurations of the apparatus and methods have been described in a specific manner referring to the illustrated embodiments, it is understood that the present invention can be applied to a wide variety of solutions which fit within the scope and spirit of the claims. There are many alternative ways of implementing the invention.

It is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. An automated tea brewing apparatus comprising:
a housing;
a heating chamber disposed within the housing and including a heating element and an electronically controlled heating chamber valve;
an infusion chamber disposed within the housing and positioned below the heating chamber, the infusion chamber comprising an electronically controlled infusion chamber valve;
a user interface disposed on the exterior of the housing;
a wireless communications module;
a controller coupled to the heating element, the heating chamber valve, the infusion chamber valve, the user interface, the wireless communications module, and a power supply;
wherein the controller is configured to implement an automated brewing process according to instructions received via the user interface or wireless communication module, the instructions including at least a water temperature and a steep time, the brewing process comprising heating liquid in the heating chamber to the designated temperature, then open the heating chamber valve and begin a timer, and then after a time has elapsed equal to the steep time, opening the infusion chamber valve.

2. The automated tea brewing apparatus of claim 1, wherein the controller is further configured to send a notification to an external device after the steeped liquid has flowed out of the infusion chamber.

3. The automated tea brewing apparatus of claim 1, wherein the instructions are based on a pre-set brewing profile stored in the controller memory or received via the wireless communications module.

4. The automated tea brewing apparatus of claim 1, wherein the instructions are manually entered by a user.

5. The automated tea brewing apparatus of claim 1, wherein the power supply comprises a rechargeable battery or a connection to an external power outlet.

6. The automated tea brewing apparatus of claim 1, further comprising a temperature sensor disposed within the heater chamber and coupled to the controller to provide real-time temperature and/or steep time information to the controller.

7. The automated tea brewing apparatus of claim 1, wherein the controller is configured to calculate an estimated time when the desired temperature will be reached in the heater chamber and control the stages of the brewing process based on the estimated time.

8. A computer-implemented method of brewing tea in an automated tea brewing apparatus, the method comprising:
receiving instructions via a user interface or a wireless communication module, the instructions including at least a water temperature and a steep time;
heating liquid in a heating chamber of the apparatus to the designated temperature based on the received instructions;
opening an electronically controlled valve of the heating chamber after reaching the designated temperature, thereby causing the heated liquid to flow into an infusion chamber of the apparatus;
beginning a timer upon the opening of the heating chamber valve;
allowing the heated liquid to steep in the infusion chamber for a time period equivalent to the steep time; and
opening an electronically controlled valve of the infusion chamber after the steep time has elapsed, thereby allowing the steeped liquid to flow out of the infusion chamber.

9. The computer-implemented method of claim 8, further comprising sending a notification to an external device after the steeped liquid has flowed out of the infusion chamber.

10. The computer-implemented method of claim 8, wherein the instructions are based on a pre-set brewing profile stored in the controller memory or received via the wireless communications module.

11. The computer-implemented method of claim 10, wherein the pre-set brewing profile is associated with a specific type of tea infusion.

12. The computer-implemented method of claim 8, further comprising tracking the number of brewed beverages based on the number of times the instructions have been received and executed.

13. The computer-implemented method of claim 12, further comprising predicting when a user will run out of tea based on the tracked number of brewed beverages and sending an alert to the user when they are predicted to run out of tea.

14. The computer-implemented method of claim 8, wherein the instructions are received via a scanning of a unique identifier associated with a specific tea infusion using an external device.

15. The computer-implemented method of claim 14, wherein the unique identifier includes information about the water temperature and steep time associated with the specific tea infusion.
